(19) United States
(12) Patent Application Publication
(10) Pub. No.: US 2015/0022175 A1
(43) Pub. Date: Jan. 22, 2015

(54) VOLTAGE LIMITER AND USE OF A VOLTAGE LIMITER TO DETERMINE VALUES OF A POWER SEMICONDUCTOR ELEMENT

(71) Applicant: Springburo GmbH, Emmendingen (DE)

(72) Inventor: Nigel Springett, Emmendingen (DE)

(21) Appl. No.: 14/333,537

(22) Filed: Jul. 17, 2014

(30) Foreign Application Priority Data
Jul. 18, 2013 (DE) 10 2013 107 699.8
Feb. 26, 2014 (EP) 14156803.0

(51) Int. Cl. H02M 3/158

(52) U.S. Cl. CPC H02M 3/158
USPC 323/282

(57) ABSTRACT

A voltage limiter for power components includes: a unipolar primary transistor, including a drain terminal connected to an input of the voltage limiter, a source terminal connected to an output of the voltage limiter, and a gate terminal connected to a predetermined potential. The gate terminal connected to the predetermined potential is configured to limit an input voltage signal at the drain terminal to a predetermined maximum value at the source terminal.

### CROSS-REFERENCE TO RELATED APPLICATIONS

Priority is claimed to German Patent Application No. DE 10 2013 107 699.8, filed on Jul. 18, 2013, and to European Patent Application No. EP 14156803.0, filed on Feb. 26, 2014, the entire disclosures of which are hereby incorporated by reference herein.

### FIELD

The invention relates to a voltage limiter for power components comprising a unipolar primary transistor, the primary transistor comprising a drain terminal which is connected to an input of the voltage limiter, a source terminal which is connected to an output of the voltage limiter, and a gate terminal. The power components are generally semiconductor elements.

### BACKGROUND

An example of a conventional voltage limiter is described in U.S. Patent Publication No. 2010/0164448 A1. Using this voltage limiter, the output signal of a voltage supply is regulated to a fixed voltage so as to prevent damage to a variable load which can be connected to the output. A gate element is provided between the input and the output of the voltage limiter, and is activated by way of a comparison voltage signal. The comparison voltage signal is generated by way of a comparison circuit, specifically in such a way that the gate element is in the saturation state for a normal or heavy load and in the linear state for a light load. For this circuit, an active comparison circuit is required which actively switches the gate element. This makes the circuit complex. In addition, the time in which the gate element can be switched is determined by the control circuit which is required for actuating the gate element. This makes the circuit relatively slow. Therefore, basically only static states are possible at the output. For example, dynamic measurement of the transitions of the input signal at the output of the voltage limiter is not possible.

### SUMMARY

In an embodiment, the invention provides a voltage limiter for power components. The voltage limiter includes: a unipolar primary transistor, including a drain terminal connected to an input of the voltage limiter, a source terminal connected to an output of the voltage limiter, and a gate terminal connected to a predetermined potential. The gate terminal connected to the predetermined potential is configured to limit an input voltage signal at the drain terminal to a predetermined maximum value at the source terminal

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a schematic drawing of a measurement construction comprising a voltage limiter according to the invention,

FIG. 2 is a schematic drawing of a first embodiment of a voltage limiter according to the invention comprising a self-conducting primary transistor,

FIG. 3 is a schematic drawing of a further embodiment of a voltage limiter according to the invention comprising a self-conducting primary transistor,

FIG. 4 is a schematic drawing of a further embodiment of a voltage limiter according to the invention comprising a self-conducting primary transistor,

FIG. 5 shows an embodiment of a voltage limiter according to the invention for measuring a power transistor,

FIG. 6, FIG. 7a and FIG. 7b show further embodiments of a voltage limiter according to the invention for measuring a power transistor,

FIG. 8 is a further embodiment of a voltage limiter according to the invention,

FIG. 9 is a further embodiment of a voltage limiter according to the invention,

FIG. 10 is an embodiment of a voltage limiter according to the invention comprising a plurality of primary transistors,

FIG. 11 shows a use according to the invention of the embodiment of the voltage limiter according to the invention from FIG. 9,

FIG. 12 shows a further use of the voltage limiter according to the invention from FIG. 9,

FIG. 13 shows a further example application of the use of the voltage limiter according to the invention, and

FIG. 14 shows a further use of the voltage limiter according to the invention.

### DETAILED DESCRIPTION

In an embodiment, the invention provides a voltage limiter of a simple construction, by way of which temporal transitions of a voltage signal at the input of the voltage limiter, for example a switch, can be measured reliably at the output thereof, and which can be used and applied more widely.

In an embodiment, a voltage limiter is provided in which the gate terminal of the primary transistor is connected to a predetermined potential, which is selected in such a way that an input voltage signal at the drain terminal is limited to a predetermined maximum value at the source terminal To provide the predetermined potential, a voltage source may be used which generates a predetermined periodic or a predetermined constant potential.

This leads to a very simple construction of the device. No additional control circuit or switching element is required for actuating the gate terminal of the primary transistor. As a result, the voltage limiter also has a very high temporal resolution. A voltage signal at the input of the voltage limiter is limited to the predetermined maximum value, in that all values below the maximum value are allowed through to the output of the voltage limiter, and all values above the maximum value are cut off. Because of the high temporal resolution of the voltage limiter, the lower part of the input voltage signal, which is below the maximum value, is available at a higher temporal resolution at the output of the voltage limiter. As a result, for example the lower part of the input voltage signal can be measured at a higher temporal resolution. This opens up many possible applications for the voltage limiter, such as measuring the voltage of electronic switches during operation, measuring the characteristic of the through-voltage of diodes during operation, measuring the voltage of electronic components during switching on or off, and determining values which are correlated with the voltage, such as barrier layer temperature, current- and temperature ratios of power components during operation.

To provide the reference potential, a DC voltage source or AC voltage source may be used, one output of which is connected to the gate terminal of the primary transistor and the other output of which is connected to the shared reference potential of the voltage limiter. The potential selected for the gate terminal is selected depending on the respective transistor type of the primary transistor. A depletion transistor or self-conducting transistor, or else an enrichment transistor or self-blocking transistor, may be used. In a self-blocking transistor, a positive potential is always selected for the gate terminal; in a self-conducting transistor, the gate terminal may also be connected to a negative potential of the DC voltage source, depending on the transistor properties and the desired maximum value.

A unipolar transistor is used as the primary transistor. These transistors have advantageous properties for the voltage limiter, such as good high-frequency properties and a rapid switching behaviour. The maximum output voltage corresponds to the gate voltage minus the gate source threshold voltage of the transistor. In the use according to the invention as a primary transistor, the maximum voltage of the voltage limiter is determined by the gate source threshold voltage of the primary transistor.

In an advantageous embodiment of the invention, an at least periodically constant predetermined potential is used as the predetermined potential. An at least periodically constant predetermined potential may be either a constant potential or a periodically alternating signal having constant signal components, which has a substantially square signal progression. This likewise limits the maximum output voltage to an at least periodically constant value.

In a further advantageous embodiment of the voltage limiter according to the invention, a self-conducting transistor, the source terminal of which is connected to the output, the drain terminal of which is connected to the input, and the gate terminal of which is connected to a shared reference potential, is provided as the primary transistor. This has the advantage that the arrangement is further simplified, since no external voltage source is required.

The voltage limiter according to the invention further has the advantage that the voltage of an electronic component at the input, for example an electronic switch, can be measured more precisely. An electronic switch typically contains a diode, a MOSFET, IGBTs, GaN transistors or a similar component. These normally have a low voltage in the conductive state and a high voltage in the blocking state. Because of the large dynamics in the voltage range, it is problematic to measure the voltage in the conductive state reliably by conventional methods.

By way of the voltage limiter according to the invention, the voltage of the switch at the output of the voltage limiter is limited to a predetermined maximum value. The maximum value is advantageously in the low-voltage range, in many applications in a range of approximately 1 volt to approximately 15 volts. This can be achieved by suitable selection of the primary transistor and the predetermined potential at the gate terminal of the primary transistor. A high-voltage transistor is used, for example having a boundary voltage of approximately 400 V or higher.

In the blocking state of the switch, the high output voltage, which may for example be between 1000 V and 2000 V, is limited to the maximum value. The lower voltage in the conductive state of the primary transistor and all voltages during the switching state which are lower than the maximum value are unchanged at the output of the voltage limiter. These voltages can thus be measured in a smaller dynamic range and thus more precisely. Conventional measurement apparatuses may be used for this purpose, for example an oscilloscope or a digital multimeter. In this way, the output voltages of the conductive state of the switch and of the switch transition can be measured at a higher resolution. Typically, the voltages in the conductive state of a switch are in the range of a few hundred mV. The maximum voltage may be selected in such a way that these voltages can be measured at a desired resolution. For this purpose, a self-conducting JFET transistor, for example, may be used as the primary transistor. The threshold voltage thereof is selected in such a way that it limits the voltage at the output to the desired maximum value. Using the voltage limiter according to the invention, a voltage signal in the high-voltage range which is passed to the input can generally be limited to a predetermined maximum value in the low-voltage range. The values of the input voltage signal which are below the maximum value can thus be measured, displayed, analysed or otherwise put to further use more precisely at the output of the voltage limiter.

In an advantageous development of the invention, the self-conducting primary transistor has a drain source capacitance of approximately 100 pF, preferably 30 pF or less. The low drain source capacitance leads to advantageous rapid reaction times of the self-conducting primary transistor. The drain source capacitance is voltage-dependent, and is selected depending on the desired properties of the voltage limiter. It is determined by the properties of the transistor. Particularly suitable materials are semiconductor materials having a wide band gap, for example silicon carbide, gallium nitride, gallium arsenide for a transistor of this type.

A further application of the voltage limiter is that the resistance of the switch can be determined from the output voltage of the voltage limiter. It may be calculated by the measurement apparatus, for example, such as an oscilloscope, and the temporal progression of the resistance can be determined Because of the good temporal resolution of the measurements, the resistance properties of the switch can also be measured during the switching process.

The aforementioned use of the voltage limiter to measure the voltage of an electronic switch is an example application and not a limitation. The voltage limiter according to the invention is suitable for measuring the voltage in electronic power apparatuses of all types during operation and determining all the properties thereof which are dependent on the voltage in the operating state, in other words correlated with the voltages. The loss in the components can be determined on the basis of the resistance curve, for example. The temperature in the region of the barrier layer of a transistor can also be determined For example, the temperature in the barrier layer of a MOSFET transistor is approximately linear with respect to the resistance, and can thus be estimated from the resistance curve. This is always possible if the characteristic of the component as a function of temperature is known. In this way, the temperature of electronic components having a barrier layer can be determined within the barrier layer during the manufacturing process.

A further advantageous use of the voltage limiter according to the invention relates to measuring diodes. PN diodes have a long switch-on time, which leads to an initial voltage rise and a subsequent decrease in voltage over time. This behaviour can be measured very precisely using the voltage limiter according to the invention, and so the switch-on time of the diode and the voltage across the diode can be precisely determined

In an advantageous development of the invention, a first protective resistor is provided between the gate terminal of the primary transistor and the constant potential.

The first protective resistor protects the gate electrode of the primary transistor when there is a negative voltage at the drain terminal The protective resistor is selected in such a way that the current through the internal diode between the drain and the source is suitably limited in the presence of negative voltages at the input. Thus, even negative input voltages are measurable. It is also favourable for a capacitor element to be arranged in parallel with the first protective resistor. As a result, the high-frequency properties of the voltage limiter can be improved. In particular, a rapid switching and reaction time of the circuit can thus be achieved.

It is further advantageous for an overvoltage protection element to be connected between the source terminal of the self-conducting primary transistor and the shared reference potential. For example, a bidirectional diode may be used for this purpose. The overvoltage protection element protects a measurement apparatus connected to the output, for example in the case of a defect in the self-conducting primary transistor.

Advantageously, a unipolar auxiliary transistor may be arranged between the primary transistor and the output of the voltage limiter. By way thereof, the maximum output voltage of the voltage limiter can additionally be limited; it can also be used to smooth the output signal and improve the high-frequency properties. Thus, an even higher resolution can be achieved for a voltage measurement. A second protective resistor may be connected between the gate terminal and the shared reference potential, and a second capacitor element parallel to said resistor. As a result, the precision of the measurement of the output voltage can be further improved. Advantageously, a low-voltage transistor, typically having a boundary voltage of approximately 40 V, may be used as the auxiliary transistor. In this case, the maximum output voltage of the voltage limiter is limited by the gate source voltage of the auxiliary transistor.

It is also preferable for a “matched pair” transistor pair of the same conduction type as the primary transistor to be arranged between the primary transistor and the output. This transistor pair is arranged in a suitable manner for compensating the offset voltage of the primary transistor between the gate terminal and the source terminal of the primary transistor. The “matched pair” transistor pair is arranged in such a way that the offset voltages of the two transistors forming the transistor pair compensate one another. As a result, the maximum output voltage of the voltage limiter may be set more precisely.

Advantageously, a voltage-limiting element is connected between the gate terminal of the primary transistor and the shared reference potential. It is favourable for the voltage-limiting element to be connected downstream from the protective resistor. This limits the maximum voltage of the gate terminal of the primary transistor, ensuring precise limitation of the output voltage of the voltage limiter. For this purpose, a Zener diode in series with a diode may be used. In this embodiment of the invention, the maximum output voltage of the voltage limiter is limited by the maximum voltage of the Zener diode and by the flux voltage of the diode, since the gate voltage of the primary transistor is controlled by the Zener diode and the diode. The gate terminal of the “matched pair” transistor pair is advantageously connected between the gate terminal and the voltage-limiting element. A protective resistor may be arranged between the gate terminal of the primary transistor and the voltage-limiting element. As a result of this arrangement, a very precise value can be achieved for the output voltage of the voltage limiter. In this embodiment of the invention, a constant output voltage and a rapid reaction time of the circuit can be achieved simultaneously.

In an advantageous embodiment of the invention, a power transistor is provided, the drain terminal of which is connected to the input of the voltage limiter, the source terminal of which is connected to a shared reference potential, and the gate terminal of which is connected to an at least periodically constant potential. In this way, the primary transistor can be used for measuring the power transistor; in particular, in this arrangement values which are correlated with the voltages of the power transistor can be determined, also including the voltages themselves. These values may be determined very precisely in particular in the low-voltage range. The gate terminal may either be connected to a DC voltage source which is connected to a shared reference potential or be connected to a shared reference potential or to a voltage source which generates a periodically constant signal such as a square signal. Also, the gate terminal of the power transistor may be connected to the gate terminal of the primary transistor. This is advantageous in particular if the power transistor and the primary transistor are transistors of the same type. The arrangement can thus be simplified. In this embodiment, the voltage of the power transistor can be measured reliably, while it is in operation, by way of the primary transistor. The power transistor can thus be tested continuously during operation.

It is further advantageous for the primary transistor to be in the form of a cell transistor of the power transistor. This is advantageous in particular if the power transistor is already formed from a number of cell transistors, as is generally the case for power transistors. In this case, the primary transistor forms part of the power transistor and is integrated into it. Correspondingly, a measurement transistor can be formed parallel to the auxiliary transistor or as an integrated cell transistor of the auxiliary transistor. An HEMT or JFET transistor is advantageously used as a power transistor. It is advantageous if an HEMT or JFET of the same conduction type is likewise used as the primary transistor.

Advantageously, a low-voltage transistor may be provided which together with the power transistor forms a cascode circuit. The drain terminal of the low-voltage transistor is connected to the source terminal of the power transistor; the gate terminals of the power transistor and of the primary transistor are connected to the shared reference potential or the constant potential. When a control signal is applied to the gate terminal of the low-voltage transistor, a current flows from the drain terminal to the shared reference potential or the constant potential. If the low-voltage transistor is switched on, the power transistor conducts; if the low-voltage transistor is switched off, the power transistor blocks. The voltage limiter thus measures the total voltage across the low-voltage transistor and the power transistor. In an advantageous embodiment, a MOSFET, in particular an n-channel transistor, is used as the low-voltage transistor, and a charge-carrier depletion JFET transistor or a similar type of transistor is used as the power transistor.

In a preferable configuration of the invention, the reference potential of the output of the voltage limiter is isolated from the reference potential of the input of the voltage limiter. The outputs are thus reliably electrically insulated from the input region of the voltage limiter circuit, in such a way that there is no electrically conductive connection between the outputs and the input region of the voltage limiter circuit. This is advantageous in particular if the input region is in the form of a high-voltage part of the voltage limiter circuit, since in this case a potential-isolation of the input voltage in the high-voltage range from the output voltage or measurement voltage in the low-voltage range is achieved. This may for example be achieved by galvanic isolation of the output from the input region. An optocoupler, which is connected linearly between operation amplifiers, may, for example, be used as the insulation medium for the galvanic isolation. Insulation transformers may also be used, which are connected between an analogue-digital converter and a digital-analogue converter, an operation amplifier being connected between the digital-analogue converter and the output for impedance adaptation. Alternatively, a difference amplifier of amplification factor 1 may be connected between the output upstream from the output of the voltage limiter.

In an advantageous embodiment of the voltage limiter, the source terminal of the primary transistor is connected to a power source, the current of which is proportional to the voltage between the source terminal of the primary transistor and the shared reference potential, and which is connected in series to an output resistor, the output voltage of the voltage amplifier being capturable at at least one part of the output resistor. In this context, the reference potential of the output is isolated from the reference potential of the input of the voltage limiter in a very simple manner. The output voltage can be captured at the output resistor or at a part of the output resistor. A further resistor may also be connected in series to the output resistor. Depending on the application, an internally supplied power source may be provided, in which the current comes from the output of the primary transistor, or an externally supplied power source may be provided, in which the current comes from an external supply unit.

In another embodiment of the voltage limiter according to the invention, a second primary transistor is provided which has a drain terminal which is connected to a second input of the voltage limiter, a source terminal which is connected to a second output of the voltage limiter, and a gate terminal which is connected to the predetermined constant potential. Thus, by way of the voltage limiter, two power components can simultaneously be measured, checked or controlled. Correspondingly, further primary transistors may be provided and connected, and correspondingly, further power components may be measured. For example, the voltage limiter may be used in monitoring the operation and state of a motor driver, such as a multi-phase motor inverter, and for measuring the current thereof, or for monitoring and controlling a switching power supply.

The voltage limiter according to the invention may advantageously be used for determining all values which are correlated with voltages in the low-voltage range of a power semiconductor element, a voltage signal of the power semiconductor element being supplied to the input of the voltage limiter as an input signal, the signal limited to the predetermined maximum value being captured at the output of the voltage limiter as an output voltage signal and processed in such a way that values correlated with the captured voltages are determined and/or displayed. Examples have been stated previously above; these include the voltages themselves. In addition, the voltage signal captured at the output of the voltage limiter according to the invention may be used for regulating an energy supply unit of an electrical device, in particular a motor or a switching power supply.

In a further advantageous use of the voltage limiter, the voltage signal captured at the output of the voltage limiter is used for monitoring the operation of a power transistor. It is further favourable if a power transistor having a blocking voltage greater than 400 V is used.

Further details, features and advantages of the present invention may be taken from the following description of preferred embodiments, with reference to the drawings.

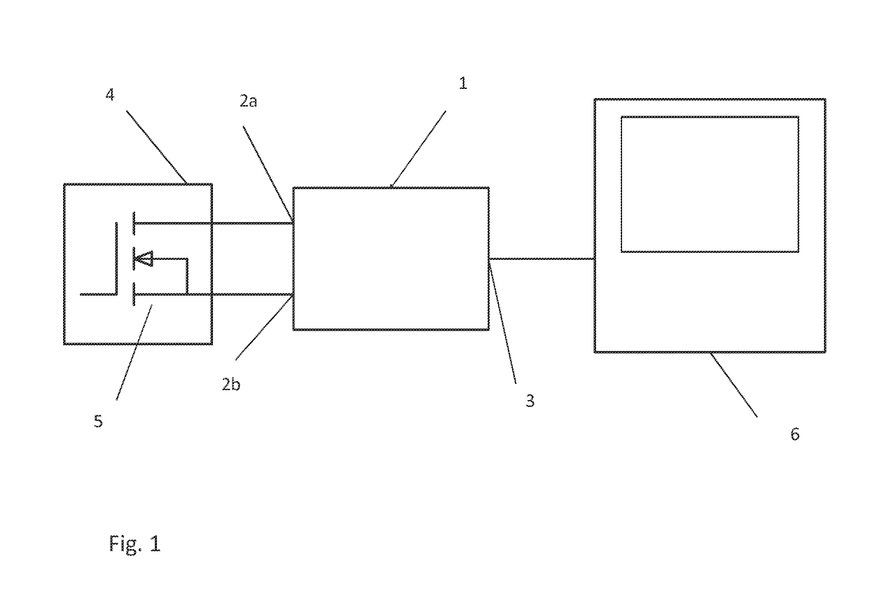

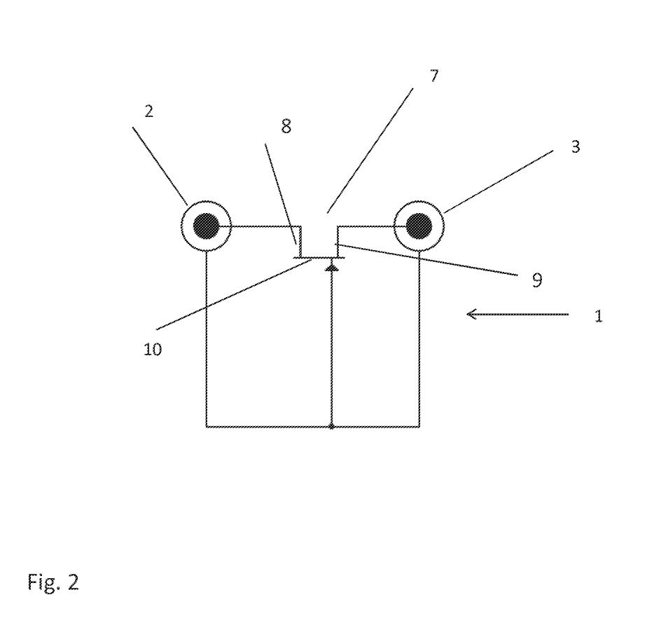

FIG. 1 shows a voltage limiter 1 comprising inputs 2a, 2b and comprising an output 3. An electronic switch 4 is connected to the inputs 2a, 2b and contains a switch transistor 5. A measurement apparatus 6 is connected to the output 3 of the voltage limiter 1, and in this case is shown as an oscilloscope. Using the voltage limiter 1, the output voltage of the switch 4 is limited to a predetermined maximum value. All values of the output voltage of the switch 4 are below the maximum value at the output 3 of the voltage limiter, and can be measured and displayed using the measurement apparatus 6. The maximum value of the output voltage of the switch 4 is selected in such a way that the voltages at the output of the voltage limiter 1 are in a range which can be measured at a desired resolution using the measurement apparatus 6. Since the voltage of a transistor, such as is used for the switch 6, for example a MOSFET transistor, is much larger in the blocking state than in the conductive state, cutting off the high voltages in the blocking state makes it possible for the voltages in the switch transition and in the conductive state of the switch to be measureable very accurately at a high resolution.

FIG. 2 shows a base circuit of the voltage resistor 1. The voltage limiter comprises a self-conducting primary transistor 7 comprising a drain terminal 8, a source terminal 9 and a gate terminal 10. The drain terminal 8 is connected to the input 2, the source terminal 9 is connected to the output 3, and the gate terminal is connected to a shared reference potential of the circuit, which may for example be the earth. Because of this circuit of the self-conducting primary transistor, it is achieved that voltages up to a predetermined maximum value at the input 2 are measureable at the output 3. Voltages above the predetermined maximum value at the input are reduced to the maximum value at the output. A self-conducting primary transistor is used, which has a maximum value suitable for the respective application. JFET, HEMT and MISFET transistors are particularly appropriate. Good properties are achieved if the self-conducting primary transistor has a drain-source capacitance of approximately 30 pF or less. This circuit of the self-conducting primary transistor 7 additionally has a rapid response time, and so dynamic processes can be measured.

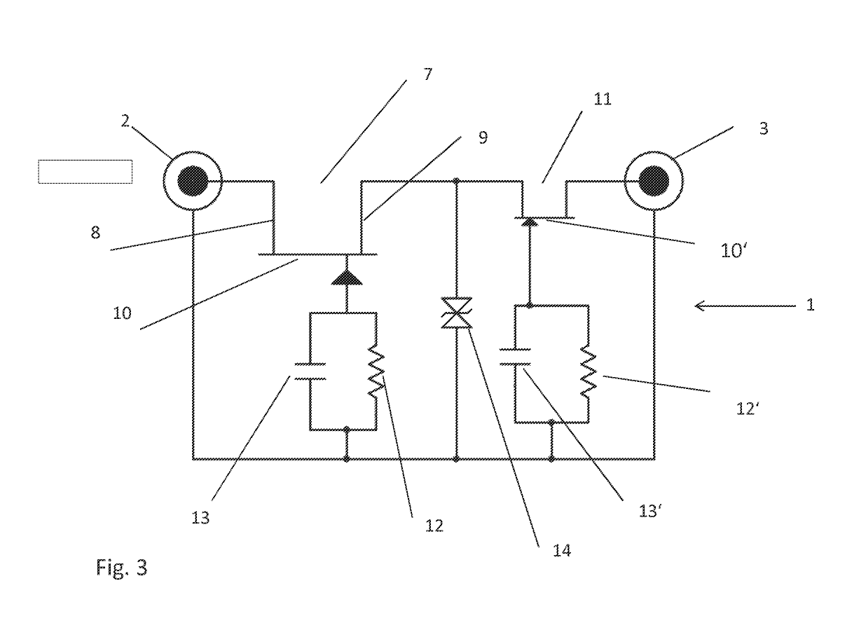

FIG. 3 shows a further embodiment of the voltage limiter 1. A self-conducting auxiliary transistor 11 is connected in series to the self-conducting primary transistor 7. Because of the auxiliary transistor 11, the maximum value of the voltage limiter 1 can be further reduced. As a result, a higher resolution can be achieved in the voltage measurement of the conductive state of the switch 4. It is also possible to connect further self-conducting transistors correspondingly in series if the maximum value of the output voltage of the voltage limiter is to be selected lower for a special application.

A first protective resistor 12, and a capacitor element 13 parallel thereto, are connected between the gate terminal 10 of the primary transistor and the shared reference potential. This makes it possible to be able to measure negative voltages at the input 2 of the voltage limiter 1 at the output 3.

Correspondingly, a second protective resistor 12′, and a second capacitor element 13′ parallel thereto, are connected between the gate terminal 10′ of the auxiliary transistor 11 and the shared reference potential. An overvoltage protection element 14 is arranged between the source terminal 9 of the primary transistor 7 and the shared reference potential, and prevents the presence of an excessively high voltage at the output 3 of the voltage limiter 1 in the event of a defect in the primary transistor 7. A bidirectional voltage-limiting diode, for example, may be used as the overvoltage protection element 14.

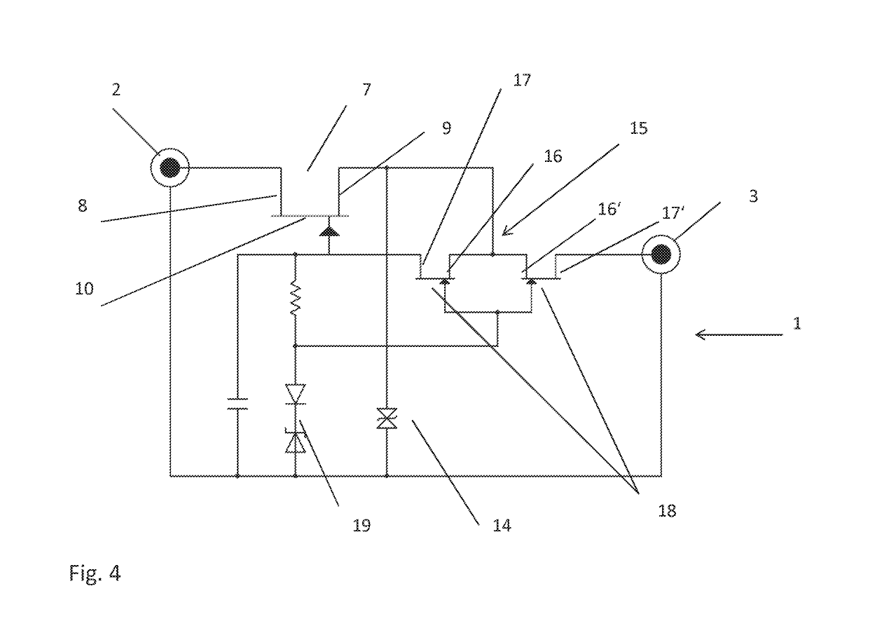

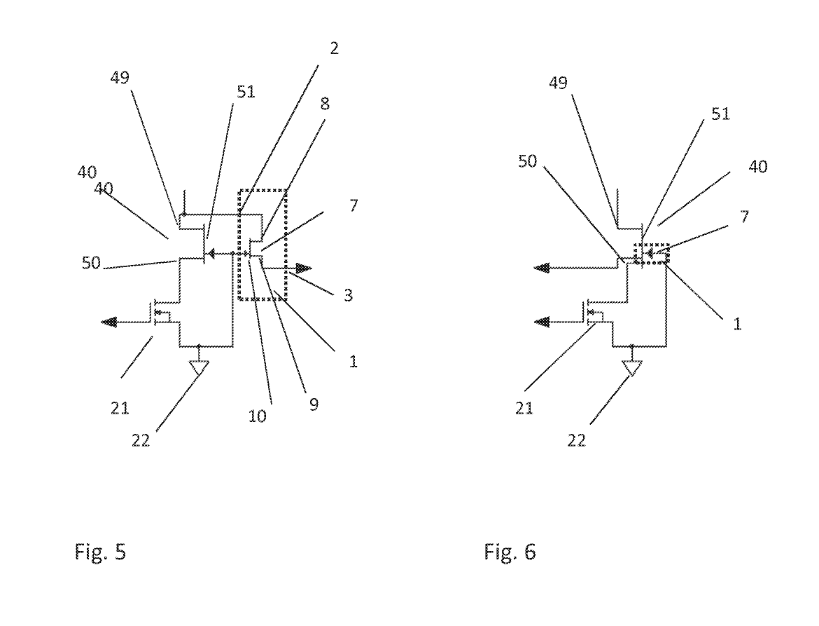

In the embodiment of FIG. 4, a transistor pair 15 is arranged between the self-conducting primary transistor 7 and the output 3 of the voltage limiter 1. The transistor pair 15 comprises two mutually tuned transistors (“matched pair”), which are likewise self-conducting transistors and of which the gate terminals 18 are interconnected. The drain terminals 16, 16′ of the two transistors are likewise interconnected. The source terminal 17 of one transistor of the transistor pair 15 is connected to the gate terminal 10 of the primary transistor 7; the source terminal 17′ of the second transistor of the transistor pair 15 is connected to the output 3. The source terminal 9 of the primary transistor 7 is connected to the drain terminals 16, 16′ of the two transistors of the transistor pair 15. A voltage-limiting element 19, which comprises a Zener diode and a diode in series, is connected between the gate terminals 18 of the two transistors of the transistor pair 15 and the shared reference potential.

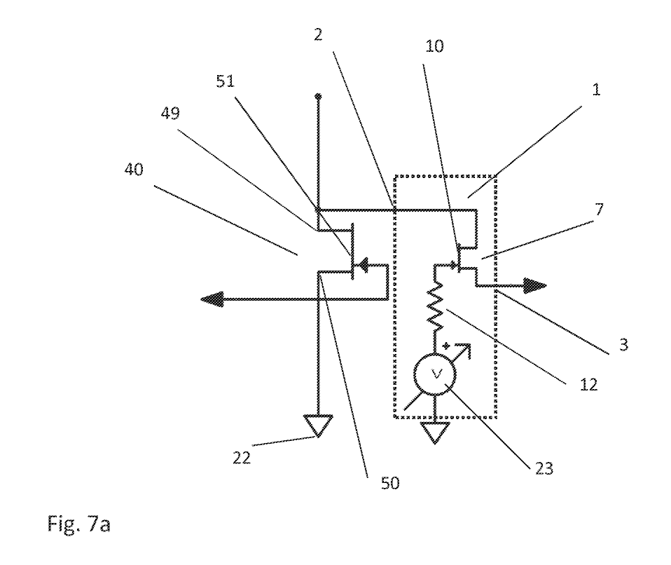

FIG. 5 shows a use of the voltage limiter 1 according to the invention for measuring a power transistor 40. The drain terminal 49 of the power transistor 40 is connected to the input 2 of the voltage limiter 1 and thus to the drain terminal 8 of the primary transistor 7. The source terminal 50 of the power transistor 40 is connected via a low-voltage transistor 21 to a shared reference potential; the gate terminal 51 of the power transistor 40 is connected to the gate terminal 10 of the primary transistor 1. The low-voltage transistor 21 and the power transistor 40 are connected in series and form a cascode circuit. The drain terminal of the low-voltage transistor 21 is connected to the source terminal of the power transistor 40; the gate terminals of the power transistor 40 and the primary transistor 7 are connected to the shared reference potential. In this case, the primary transistor 7 is a self-conducting transistor. When a control signal is applied to the gate terminal of the low-voltage transistor 21, a current flows from the drain terminal to the shared reference potential or the constant potential. If the low-voltage transistor is switched on, the power transistor conducts; if the low-power transistor is switched of, the power transistor blocks. The voltage limiter 1 measures the total voltage across the low-voltage transistor 21 and the power transistor 40. In an advantageous embodiment, an n-channel transistor is used as the low-voltage transistor. In this case, a charge-carrier depletion JFET transistor or a transistor of a similar type of transistor may be used as the power transistor. The power transistor 40 can thus be measured or checked during operation. Using the primary transistor 7, the voltage progression of the power transistor 40 can thus be measured during operation. Analogously to what is disclosed above, further variables can also be determined by way of the primary transistor 7, for example the resistance properties of the power transistor 40, the temperature and time properties thereof or other variables. Since the low-voltage transistor is actuated by low voltages, for example in the range of a few tens of volts, the switching of the power transistor 40 may take place by way of actuation in the low-voltage range.

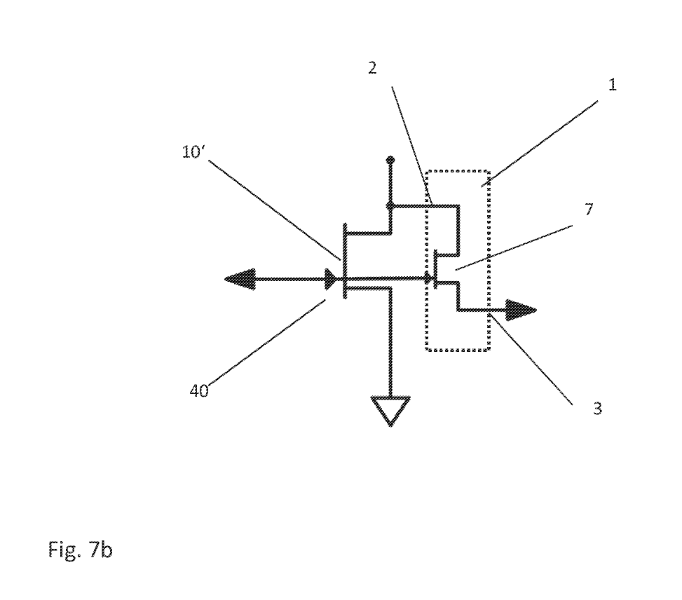

In the embodiment of the self-conducting primary transistor 7 shown in FIG. 6, the primary transistor 7 is integrated into the power transistor 40. In the embodiment shown, the power transistor 40 is a self-conducting transistor which comprises a plurality of cell-transistors connected in parallel. One or more of these cell transistors is formed as a primary transistor 7 which is connected as a voltage limiter 1, and can thus be used as a measurement transistor.

FIG. 7a shows the use of the voltage limiter 1 to measure the voltage and further properties of the power transistor 40, in which a self-blocking or self-conducting transistor can be used as a primary transistor 7. The gate terminal 10 of the primary transistor 7 is connected to the gate terminal 51 of the power transistor 40, and can be charged with a periodically constant or a constant potential. The drain terminal 49 off the power transistor 40 is connected to the input 2 of the voltage limiter 1. The source terminal 50 of the power transistor 40 is connected to a shared reference potential. The source terminal 9 of the primary transistor 7 is connected to the output 3 of the voltage limiter 1. At the output 3, a voltage signal of the power transistor 40 limited to the predetermined maximum value can be captured. From this, values correlated with the voltages of the limited voltage signal can be determined

In the embodiment of FIG. 7b, the gate terminal 51 of the power transistor 40 is charged with a constant or periodically constant potential. The gate terminal 10 of the primary transistor 7 is connected via the protective resistor 12 to a DC voltage source 23, which is in turn connected to shared reference potential 22. The arrangement and mode of operation otherwise correspond to those of FIG. 7a. In the arrangement of FIG. 7b, different transistor types can be used for the power transistor 40 and the primary transistor 7.

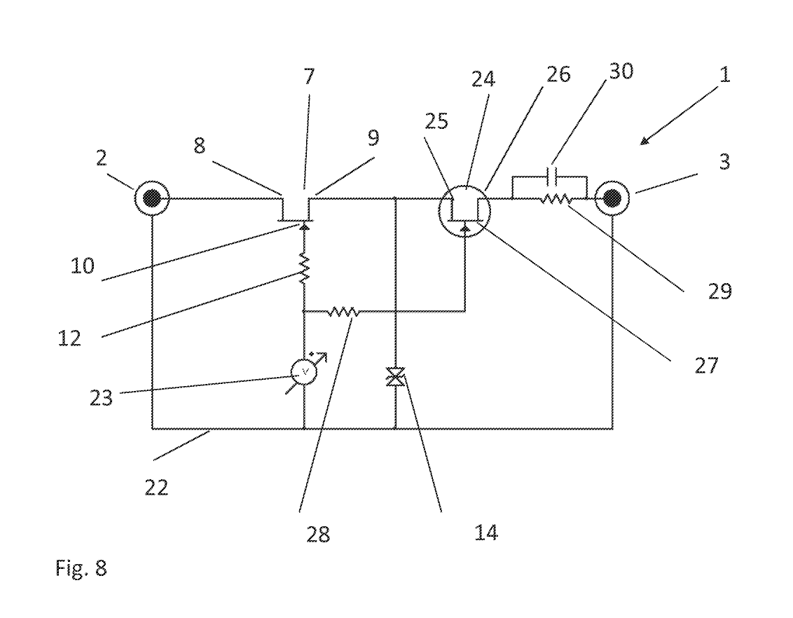

FIG. 8 shows an embodiment of the voltage limiter 1 according to the invention, in which both a self-conducting and a self-blocking transistor may be used as the primary transistor 7. The gate terminal 10 of the primary transistor 7 is connected via the protective resistor 12 to a DC voltage source 23, by way of which the gate terminal 10 is charged with a constant potential. The DC voltage source 23 is connected to the shared reference potential 22. A secondary transistor 24, the drain terminal 25 of which is connected to the source terminal 9 of the primary transistor 7, the source terminal 26 of which is connected to the output 3 of the voltage limiter, and the gate terminal 27 of which is connected via a second protective resistor 28 to the DC voltage source 23, is connected in series to the primary transistor 7. By way of the DC voltage source 23, the gate terminals 10, 27 of the primary transistor 7 and of the secondary transistor 24 are controlled in such a way that the input signal is reduced to a predetermined maximum value. By way of the secondary transistor 24, the signal properties of the signal reduced by the primary transistor are improved. By way of the voltage source 23, the gate terminals can be controlled both with a negative and with a positive voltage signal. Therefore, a desired maximum value can be set both in a self-conducting and in a self-blocking transistor.

A resistance element 29, together with a capacitive element 30 connected in parallel, is provided between the source terminal 26 of the secondary transistor 24 and the output 3 of the voltage limiter 1, and these bring about a high-frequency compensation at the output 3 for a capacitive load of an apparatus connected to the output 3. The overvoltage protection element 14 connected between the source terminal 9 of the primary transistor 7 and the shared reference potential serves to protect a measurement apparatus connected to the output in the case of a defect in the self-conducting primary transistor 7.

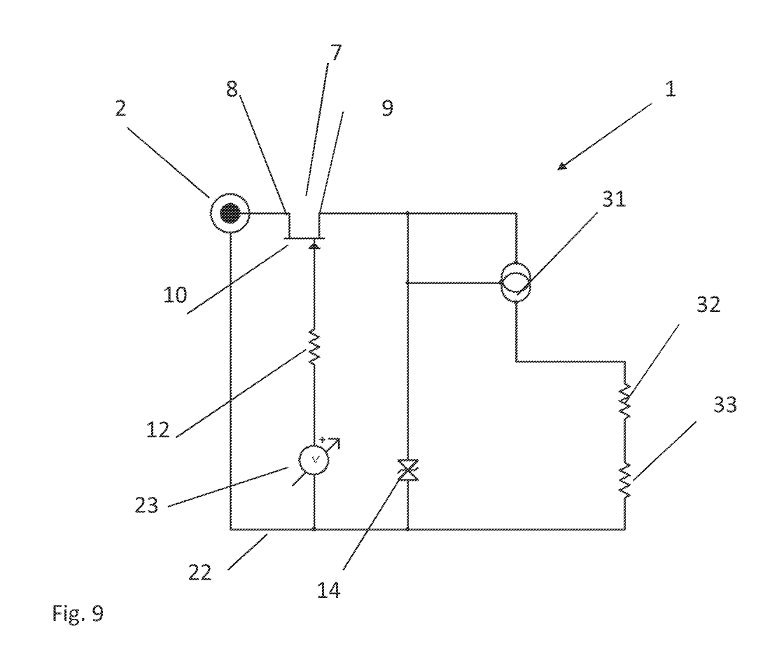

In the embodiment of FIG. 9, the gate terminal 10 of the primary transistor 7 is likewise connected to the potential of a DC voltage source 23 via a protective resistor 12. In this embodiment, to isolate the reference potential of the output of the voltage limiter 1 from the reference potential of the input 2 of the voltage limiter 1, a power source 31 is provided, which is arranged in such a way that the current thereof is proportional to the voltage between the source terminal of the primary transistor and the shared reference potential. It is connected to the source terminal 9 of the primary transistor 7 and connected to the shared reference potential 22 in series via the output resistors 32, 33. A first and a second output resistor 32, 33 are connected between the power source 31 and the shared reference potential 22. Typically, the output signal is captured at the second output resistor 33. As a result, isolation of the reference potential of the output of the voltage limiter 1 from the reference potential of the output 2 of the voltage limiter 1 is brought about in a very simple manner.

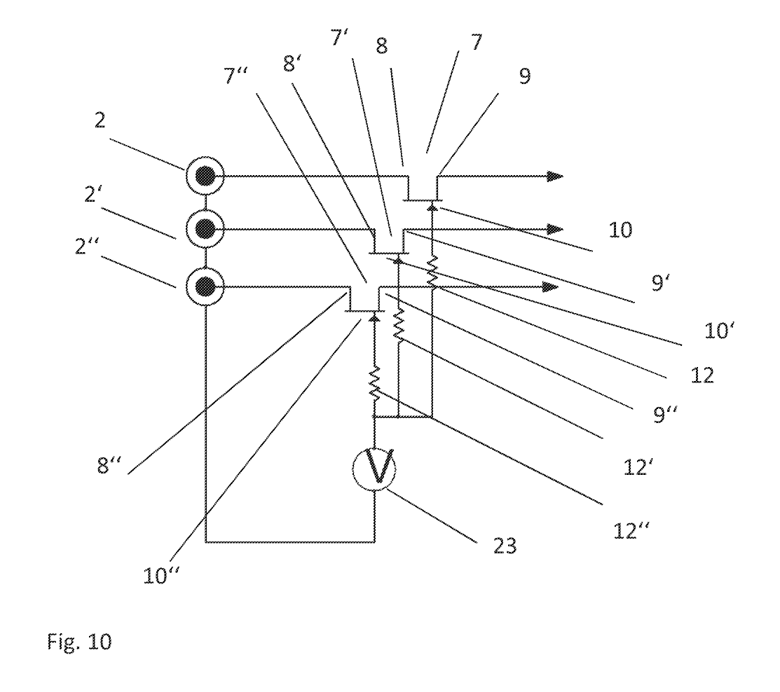

FIG. 10 shows an embodiment in which 3 primary transistors 7, 7′, 7″ are connected in parallel. Each of the primary transistors 7, 7′, 7″ is connected via the drain terminal 8, 8′, 8″ thereof to the input 2, 2′, 2″ of the voltage limiter 1. The gate terminals 10, 10′, 10″ of the primary transistors 7, 7′, 7″ are each connected to a DC voltage source 23 via a protective resistor 12, 12′, 12″, and are charged with a voltage potential in such a way that the primary transistors 7, 7′, 7″of an input voltage signal present at the respective drain terminal 8, 8′, 8″ only let through the values which are below a predetermined maximum. The voltage signals limited in this manner are available at the respective output of the voltage limiter 1. This is a special embodiment, which does not imply a limitation of the invention. Further primary transistors may also be connected in parallel in the same manner, or other embodiments of the primary transistors and the circuitry thereof may be used or combined.

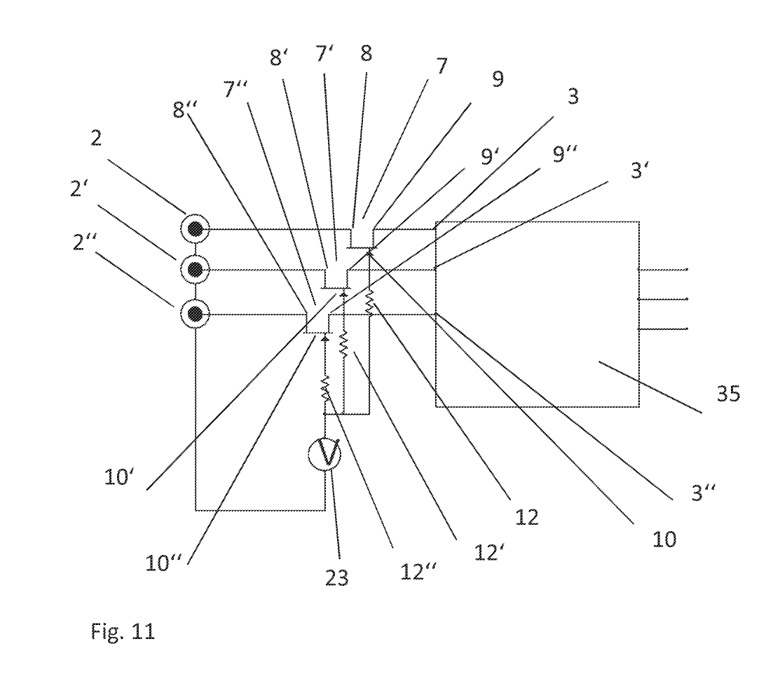

FIG. 11 is a schematic drawing of an example application of the voltage limiter 1, which has three outputs 3, 3′, 3″. The outputs 3, 3′, 3″ of the voltage limiter 1 are connected to a control unit 35. In this embodiment, signals passed to the inputs 2, 2′, 2″ are limited to a maximum value by way of the primary transistors 7, 7′, 7″ and used for controlling an apparatus connected to the control unit 35. For example, this may be a PWM (pulse-width modulation) control unit, via which a respective output voltage or a respective output current for each output 3, 3′, 3″ of the voltage limiter 1 is controlled. By way of the limited output signals of the voltage limiter 1, pulse-width modulation may take place in the PWM control unit. As a result, for example the current supply to electrical devices, in particular to inert masses such as motors, can be controlled. This application may for example take place even with the embodiment of the voltage limiter 1 having only a primary transistor 7 or having another number, suitable for the respective application, of primary transistors 7 connected in parallel.

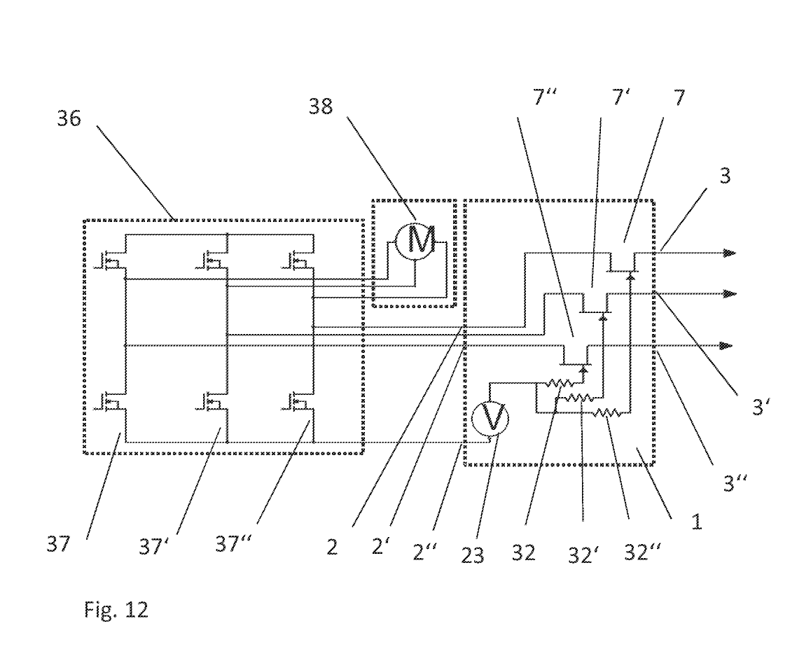

FIG. 12 schematically shows the use of an embodiment of the voltage limiter 1 for monitoring a motor drive. A motor drive unit 36 comprises three transistor pairs 37, 37′, 37″ which are respectively connected to the feed lines of a three-phase motor 38. A voltage limiter 1 having three inputs 2, 2′, 2″, three outputs 3, 3′, 3″ and three primary transistors 7, 7′, 7″ is provided. The inputs 2, 2′, 2″ of the voltage limiter 1 are each connected to one of the transistor pairs 37, 37′, 37″ of the motor driver unit, a voltage signal being captured in each case between the transistor pairs 37, 37′, 37″. By way of the DC voltage source 23, the predetermined maximum values of the primary transistors 7, 7′, 7″ are set. The signals, limited to the maximum value, of the motor driver unit 38 are passed from the outputs 3, 3′, 3″ of the voltage limiter 1 to the control unit (not shown) for monitoring and protecting the driver unit 36 and the motor 38.

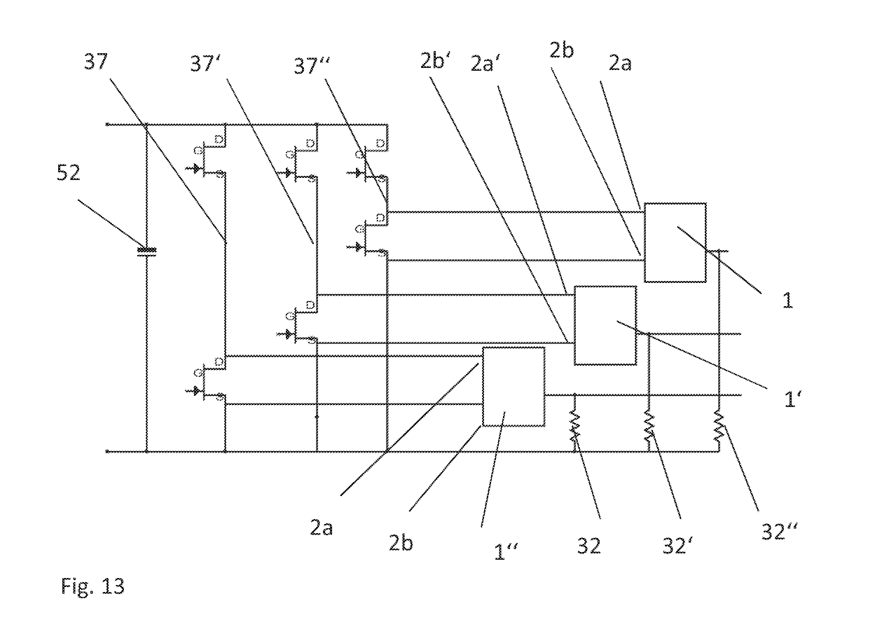

FIG. 13 shows a similar use for the voltage limiter 1 to that in FIG. 1. In this case, three voltage limiters 1, 1′, 1″ are used, which each have an input 2, 2′, 2″. In each case the source-drain voltage of a primary transistor 7, 7′, 7″ of a transistor pair 37, 37′, 37″ is passed to the respective input 2, 2′, 2″ of a respective voltage limiter. The output voltage of the voltage limiter 1, 1′, 1″ can in each case be captured via an output resistor 32, 32′, 32″. Because of the high currents, the source terminals of the primary transistors 7, 7′, 7″ do not have the same voltage in this case. Therefore, they cannot be interconnected, since a high current would flow in the voltage limiters 1, 1′, 1″. As a result, the noise at the source terminals could become greater than the measurement signal. In this case, it is advantageous if voltage limiters 1, 1′, 1″ are used, upstream from the output 3, 3′, 3″ of each of which a power source is arranged, as was disclosed in connection with the embodiment of FIG. 9. Subsequently, the output voltage of each of the voltage limiters 1, 1′, 1″ is present at the respective output resistor 32, 32′, 32″ of the voltage limiters 1, 1′, 1″. Subsequently, the voltages of the individual primary transistors 7, 7′, 7″ can be measured mutually independently. As a result, the reference potentials of the input and the output of each voltage limiter can be isolated from one another locally. The noise and an offset voltage in the source connections of the primary transistors 7, 7′, 7″ can thus be eliminated from the output signal. The measured voltages can subsequently be combined again at a shared point. A capacitor 52 is provided to prevent high-frequency interferences.

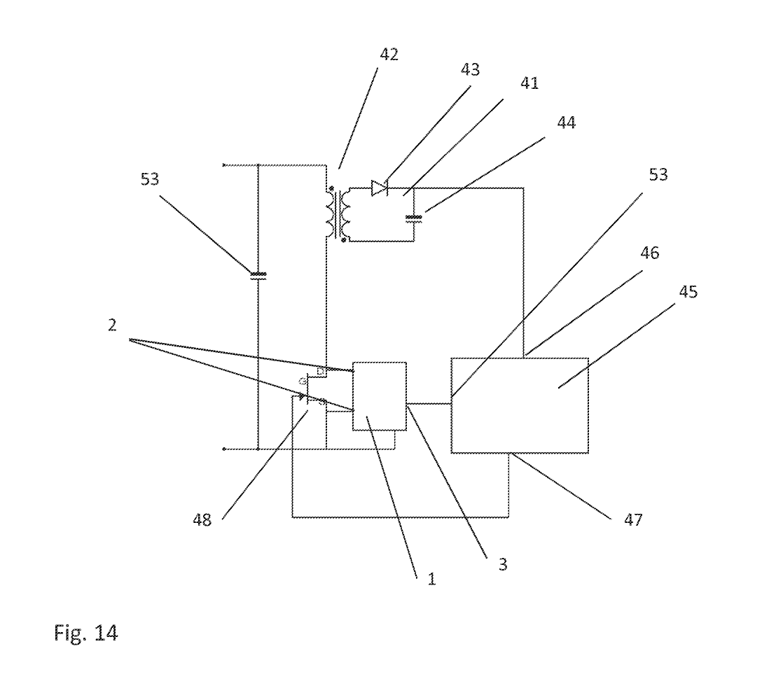

FIG. 14 shows the use of the voltage limiter 1 according to the invention for regulating a switching power supply 41. The exemplary switching power supply shown comprises a transformer 42, a rectifier element 43 and a smoothing capacitor 44. A voltage source 53 is provided to supply power. Further, a PWM (pulse-width modulation) control unit 45 is provided, the first input 46 of which is connected to the switching power supply 41, the second input 53 of which is connected to the voltage limiter 1, and the output 47 of which is connected to the gate terminal of a power transistor 48. The source terminal and the drain terminal of the power transistor 48 are each connected to the input 2 of the voltage limiter 1. The drain terminal of the power transistor 48 is connected to a primary winding of the transformer 42, and the source terminal is connected to a shared potential to which the voltage limiter 1 is also connected. The output voltage signal of the switching power supply 41 is measured in the PWM control unit 45, with the signal modulated by the voltage limiter 1. The output voltage signal of the PWM control unit is regulated in such a way that a predetermined target value is achieved. Using the output signal of the output 47, the power transistor 48 is regulated in such a way, via the gate terminal thereof, that a regulated current supply to the primary winding of the transformer 42 is ensured.

Using the voltage limiter 1, the output voltage of the regulating transistor 48 can reliably be measured, displayed and monitored. The same applies to properties of the regulation transistor 48 which are correlated with the output voltage thereof In particular, in this way the current of the power transistor 48 can be monitored. In the art, a current resistor or a current transformer is used for this purpose. These are therefore no longer necessary.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 Voltage limiter
2, 2a, 2b Input
3 Output
4 Switch
5 Switch transistor
6 Measurement apparatus
7 Primary transistor
8 Drain terminal
9 Source terminal
10, 10′, 10″ Gate terminal
11 Auxiliary transistor
12, 12′ Protective resistor
13, 13′ Capacitor element
14 Overvoltage protection element
15 Transistor pair
16, 16′ Source terminal of the transistor pair
17, 17′ Drain terminal of the transistor pair
18 Gate terminals of the transistor pair
19 Voltage-limiting element
20 Measurement transistor
21 Low-voltage transistor
22 Shared reference potential
23 DC voltage source
24 Secondary transistor
25 Drain
26 Source
27 Gate
28 Second protective resistor
29 Resistor element
30 Capacitive element
31 Power source
32 Output resistor
33 Output resistor
35 Control unit
36 Motor
37 Transistor pair
38 Motor
40 Power transistor
41 Switching power supply
42 Transformer
43 Rectifier element
44 Smoothing capacitor
45 PWM control unit
46 First input of the PWM
47 Output of the PWM
48 Power transistor
49 Drain terminal of the power transistor
50 Source terminal of the power transistor
51 Gate terminal of the power transistor
52 Capacitor
53 Voltage source

1. A voltage limiter for power components, comprising:
a unipolar primary transistor, comprising a drain terminal connected to an input of the voltage limiter, a source terminal connected to an output of the voltage limiter, and a gate terminal connected to a predetermined potential;
wherein the gate terminal connected to the predetermined potential is configured to limit an input voltage signal at the drain terminal to a predetermined maximum value at the source terminal

2. The voltage limiter according to claim 1, where the predetermined potential is at least periodically constant.

3. The voltage limiter according to claim 1, wherein the primary transistor is a self-conducting transistor, and the gate terminal is connected to a shared reference potential.

4. The voltage limiter according to claim 3, further comprising:
an overvoltage protection element connected between the source terminal of the primary transistor and the shared reference potential.

5. The voltage limiter according to claim 1, further comprising:
a first protective resistor arranged between the gate terminal of the primary transistor and the predetermined potential; and
a capacitor element arranged in parallel with the first protective resistor.

6. The voltage limiter according to claim 1, further comprising:
a unipolar auxiliary transistor arranged in series with the primary transistor.

7. The voltage limiter according to claim 1, further comprising:
a “matched pair” transistor pair of the same conduction type as the primary transistor, arranged between the primary transistor and the output.

8. The voltage limiter according to claim 1, further comprising:
a power transistor, the power transistor comprising a drain terminal connected to the input of the voltage limiter, a source terminal connected to a shared reference potential, and a gate terminal connected to an at least periodically constant potential.

9. The voltage limiter according to claim 8, wherein the gate terminal of the power transistor is connected to the gate terminal of the primary transistor.

10. The voltage limiter according to claim 8, wherein the primary transistor is in a cell transistor of the power transistor.

11. The voltage limiter according to claim 1, wherein a reference potential of the output of the voltage limiter is isolated from a reference potential of the input of the voltage limiter.

12. The voltage limiter according to claim 1, wherein the source terminal of the primary transistor is connected to a power source, the current of the power source being proportional to the voltage between the source terminal of the primary transistor and a shared reference potential, wherein the power source is connected in series to an output resistor, and wherein the output voltage of the voltage amplifier is capturable at at least one part of the output resistor.

13. The voltage limiter according to claim 1, further comprising:
a second primary transistor, the second primary transistor comprising a drain terminal connected to a second input of the voltage limiter, a source terminal connected to a second output of the voltage limiter, and a gate terminal connected to the same potential as the gate terminal of the first primary transistor.

14. A method of using a voltage limiter for determining values correlated with voltages in a low-voltage range of a power semiconductor element, the voltage limiter comprising a unipolar primary transistor comprising a drain terminal connected to an input of the voltage limiter, a source terminal connected to an output of the voltage limiter, and a gate terminal connected to a predetermined potential, wherein the gate terminal connected to the predetermined potential is configured to limit an input voltage signal at the drain terminal to a predetermined maximum value at the source terminal, the method comprising:
supplying a voltage signal of the power semiconductor element to an input of the voltage limiter as an input signal and capturing a voltage signal at the output of the voltage limiter, the input signal being limited to the predetermined maximum value at the output of the voltage limiter as an output voltage signal; and
processing the voltage signal to correlate the captured voltages with the values to be determined

15. The method according to claim 14, wherein the voltage signal captured at the output of the voltage limiter is used to regulate an energy supply unit of a motor or a switching power supply.

16. The method according to claim 14, wherein the voltage signal captured at the output of the voltage limiter is used for protecting a motor or a switching power supply from overcurrent or overload.

17. The method according to claim 14, wherein the voltage signal captured at the output of the voltage limiter is used for monitoring the operation of a power transistor.
